(19) United States
(12) Patent Application Publication
(10) Pub. No.: US 2008/0241628 A1
(43) Pub. Date: Oct. 2, 2008

(54) MEMBRANE-ELECTRODE ASSEMBLY FOR SOLID POLYMER ELECTROLYTE FUEL CELL

(75) Inventors: Takaki Nakagawa, Saitama (JP); Nagayuki Kanaoka, Saitama (JP); Ryohei Ishimaru, Saitama (JP)

Correspondence Address: ARENT FOX LLP, 1050 CONNECTICUT AVENUE, N.W., SUITE 400, WASHINGTON, DC, 20036, US

(73) Assignee: HONDA MOTOR CO. LTD., Minato-ku (JP)

(21) Appl. No.: 12/057,003

(22) Filed: Mar. 27, 2008

(30) Foreign Application Priority Data
Mar. 30, 2007 (JP) 2007-091621

(51) Int. Cl. H01M 8/10

(52) U.S. Cl. 429/33

(57) ABSTRACT

An object of the present invention is to provide a membrane-electrode assembly for solid polymer electrolyte fuel cells, which can impart high electrical properties by increasing the introduction amount of the sulfonic acid group, has excellent swell suppression effect even under the humidified condition of high-temperature, and which has excellent electrical properties even under the condition of high-temperature and low-humidity. By using sulfonated polyarylene having specific constitutional units as a proton conductive membrane, a membrane-electrode assembly for solid polymer electrolyte fuel cells can be provided which has excellent swell suppression effect even under the humidified condition of high-temperature, and which has excellent proton conductivity even under the condition of high-temperature and low-humidity.

This application is based on and claims the benefit of priority from Japanese Patent Application No. 2007-091621, filed on 30 Mar. 2007, the content of which is incorporated herein by reference.

### BACKGROUND OF THE INVENTION

1. Field of the Invention

The present invention relates to a membrane-electrode assembly for solid polymer electrolyte fuel cells.

2. Related Art

Polymer electrolyte is a polymer material having a protonic acid group such as sulfonic acid in the polymer chain. Also, because of the properties that the polymer electrolyte is tightly bound to particular ions and that the polymer electrolyte selectively transmits cations or anions, the polymer electrolyte is utilized for various purposes by forming into particles, fibers or membranes.

For example, a solid polymer electrolyte fuel cell is a cell, in which: a pair of electrodes are provided on the opposite sides of a solid polymer electrolyte membrane (proton conductive membrane) with proton conductivity; a fuel gas containing hydrogen such as a reforming gas is supplied to one electrode (a fuel electrode); and an oxidant gas containing oxygen such as air is supplied to the other electrode (an air electrode), thereby extracting a chemical energy, which is generated in oxidation of the fuel, directly as an electrical energy.

It is known that the power-generating efficiency of the solid polymer electrolyte fuel cell increases as the operation temperature of the cell rises. Also, the electrodes bonded to the opposite sides of the proton conductive membrane contain a platinum electrode catalyst, and platinum is poisoned even by a slight amount of carbon monoxide. This results in reduction of output of the fuel cell. Moreover, it is known that the poisoning of the platinum electrode catalysts by carbon monoxide becomes significant at lower temperature. Consequently, it is desired to elevate the operation temperature of the cell in order to improve the power-generating efficiency and to reduce the poisoning of the electrode catalyst by carbon monoxide. Furthermore, in order to achieve proton conductivity performance of the polymer electrolyte membrane at the time of generating power, moisture content in the membrane is important. Therefore, sufficiently humidified fuel gas is generally used.

However, the use under a humidified condition of high temperature causes problems such as dimensional changes of the polymer electrolyte membrane. Moreover, the perfluoro electrolyte, which is known as a polymer electrolyte having proton conductivity, and which is represented by Nafion (registered trademark, supplied by DuPont), is non-crosslinked, leading to problems that the perfluoro electrolyte has low heat-resistance, and cannot be used at high temperature.

On the other hand, in order to improve the high-temperature durability, a polymer electrolyte has been studied, in which sulfonic acid groups and the like are introduced into hydrocarbon polymers such as aromatic polyarylene ether ketones, aromatic polyarylene ether sulfones or the like (for example, see U.S. Pat. No. 5,403,675, Polymer Preprints, Japan, Vol. 42, No. 3, p. 730 (1993), Polymer Preprints, Japan, Vol. 42, No. 7, p. 2490-2492 (1993), Polymer Preprints, Japan, Vol. 43, No. 3, p. 736 (1994)).

However, in general, there are problems that such polymer electrolytes exhibit high water absorption and degree of swelling under a humidified condition of high temperature, and therefore are poor in the dimensional stability. Moreover, when the sulfonic acid concentration is reduced in order to suppress the swelling, the proton conductivity significantly deteriorates. Furthermore, there is a problem that the sulfonic acid group is eliminated or decomposed by continual usage under the condition of high temperature, leading to low durability.

In addition to the problems described above, a complex system is required in order to humidify the fuel gas, therefore an operation available under a high-temperature and low-humidity environment has been demanded in order to improve the efficiency of the fuel sell system. However, under a high-temperature and low-humidity environment, there is a problem that water retentivity of the polymer electrolyte membrane is reduced, leading to reduction of proton conductivity.

Therefore, an object of the present invention is to provide a membrane-electrode assembly for solid polymer electrolyte fuel cells, which can impart high electrical properties by increasing the introduction amount of the sulfonic acid group, and which has excellent swell suppression effect even under the humidified condition of high-temperature, and has excellent electrical properties even under the condition of high-temperature and low-humidity.

### SUMMARY OF THE INVENTION

### Means for Solving the Problems

The present inventors have conducted extensive research in order to solve the problems described above. As a result, the inventors have found that the abovementioned problems are solved by providing a membrane-electrode assembly for solid polymer electrolyte fuel cells, in which a sulfonated polyarylene having specific constitutional units is used as a proton conductive membrane, and completed the present invention. More specifically, the present invention provides what is described below.

(1) In a first aspect, there is provided a membrane-electrode assembly for solid polymer electrolyte fuel cells, in which: an anode electrode is provided to one surface of a proton conductive membrane; and a cathode electrode is provided to another surface of the proton conductive membrane, the proton conductive membrane including a constitutional unit expressed by the following general formula (1′):

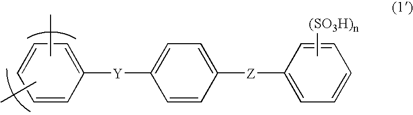

wherein, Y represents —CO— or —SO₂—; Z represents a direct bond, —CO—, —SO₂— or —SO—; and n represents an integer of 2 to 5.

(2) In a second aspect, there is provided a membrane-electrode assembly for solid polymer electrolyte fuel cells according to the first aspect, wherein the proton conductive membrane further includes a constitutional unit expressed by the following general formula (2):

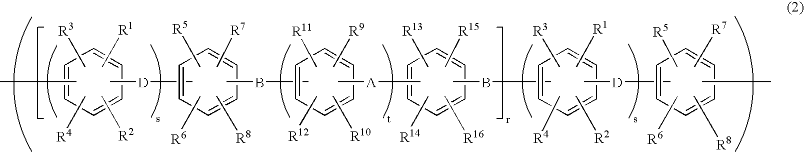

wherein, A and D each independently represent at least one structure selected from the group consisting of a direct bond, —O—, —S—, —CO—, —SO₂—, —SO—, —CONH—, —COO—, —(CF₂)ᵢ— (i is an integer of 1 to 10), —(CH₂)ⱼ— (j is an integer of 1 to 10), —CR′₂— (R′ represents an aliphatic hydrocarbon group, aromatic hydrocarbon group, or halogenated hydrocarbon group), a cyclohexylidene group, and a fluorenylidene group; B independently represents an oxygen atom or a sulfur atom; R¹ to R¹⁶ may be identical or different from each other, and represent at least an atom or a group selected from the group consisting of a hydrogen atom, fluorine atom, alkyl group, partially or fully halogenated alkyl group, allyl group, aryl group, nitro group and nitrile group; s and t are each independently an integer of 0 to 4; and r is an integer of 0 or not less than 1.

(3) In a third aspect, there is provided a membrane-electrode assembly for solid polymer electrolyte fuel cells according to the first or second aspect, wherein the constitutional unit expressed by the above general formula (1′) is a constitutional unit expressed by the following general formula (1′a):

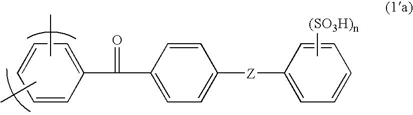

wherein, Z represents a direct bond, —CO—, —SO₂— or —SO—; and n represents an integer of 2 to 5.

### Effects of the Invention

According to the present invention, since sulfonated polyarylene with high sulfonic acid concentration is used as a proton conductive membrane, it is possible to provide a membrane-electrode assembly for solid polymer electrolyte fuel cells, which has high proton conductivity, and which has an excellent swell-suppressing effect even under the humidified environment of high temperature. Moreover, sulfonated polyarylene, in which a plurality of sulfonic acid groups are bonded to an identical aromatic ring, is used as a proton conductive membrane. This improves the acidity of the sulfonic acid, and makes it possible to provide a membrane-electrode assembly for solid polymer electrolyte fuel cells, which has high hydrophilic sulfonic acid concentration, and which can maintain excellent proton conductivity even under the high-temperature and low-humidity environment.

### DETAILED DESCRIPTION OF THE INVENTION

Embodiments of the present invention will be explained in detail below.

### [Aromatic Sulfonic Ester]

The sulfonated polyarylene used for forming the proton conductive membrane of the membrane-electrode assembly for solid polymer electrolyte fuel cells according to the present invention is derived from an aromatic sulfonic ester expressed by the following general formula (1).

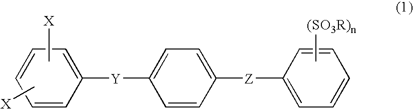

In the formula (1), X represents an atom or group selected from the group consisting of a halogen atom other than fluorine, i.e., a chlorine, bromine or iodine atom, —OSO₂CH₃, and —OSO₂CF₃, and preferably a halogen atom. Y represents —CO— or —SO₂—, and preferably —CO—. Z represents a direct bond, CO—, SO₂— or —SO—, and preferably a direct bond. n represents an integer of 2 to 5, and preferably 2 or 3.

R independently represents a hydrocarbon group with 4 to 20 carbon atoms. Specifically, examples of R include linear hydrocarbon groups, branched hydrocarbon groups, alicyclic hydrocarbon groups and the like, such as t-butyl, sec-butyl, isobutyl, n-butyl, n-pentyl, neopentyl, cyclopentyl, n-hexyl, cyclohexyl, heptyl, octyl, 2-ethylhexyl, cyclopentylmethyl, adamanthyl, cyclohexylmethyl, adamanthylmethyl, tetrahydrofurfuryl, 2-methylbutyl, 3,3-dimethyl-2,4-dioxolanemethyl, bicyclo[2.2.1]heptyl, and bicyclo[2.2.1]heptylmethyl groups.

Among these, in order to derive the sulfonated polyarylene to be described later, the hydrocarbon group is preferably a neopentyl, tetrahydrofurfuryl, cyclopentylmethyl, cyclohexylmethyl, adamanthylmethyl or bicyclo[2.2.1]heptylmethyl group, and more preferably a neopentyl group.

As such an aromatic sulfonic ester, the followings are exemplified.

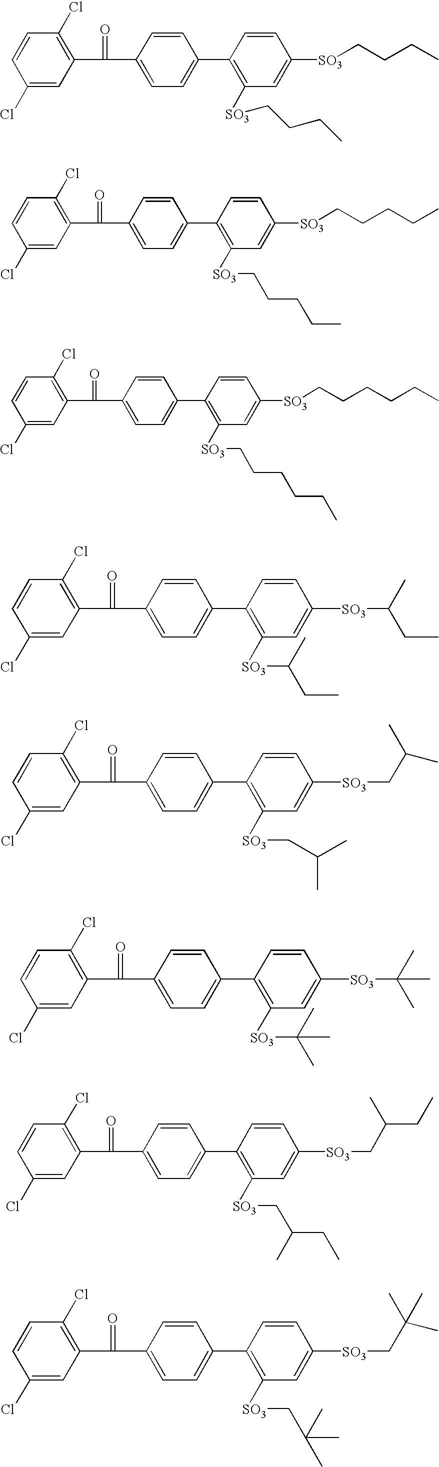

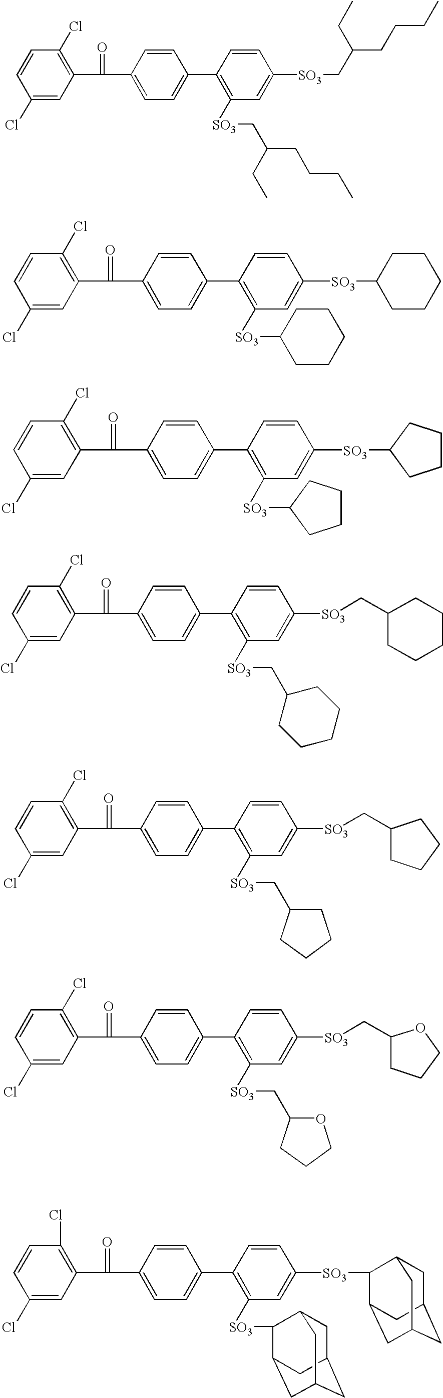

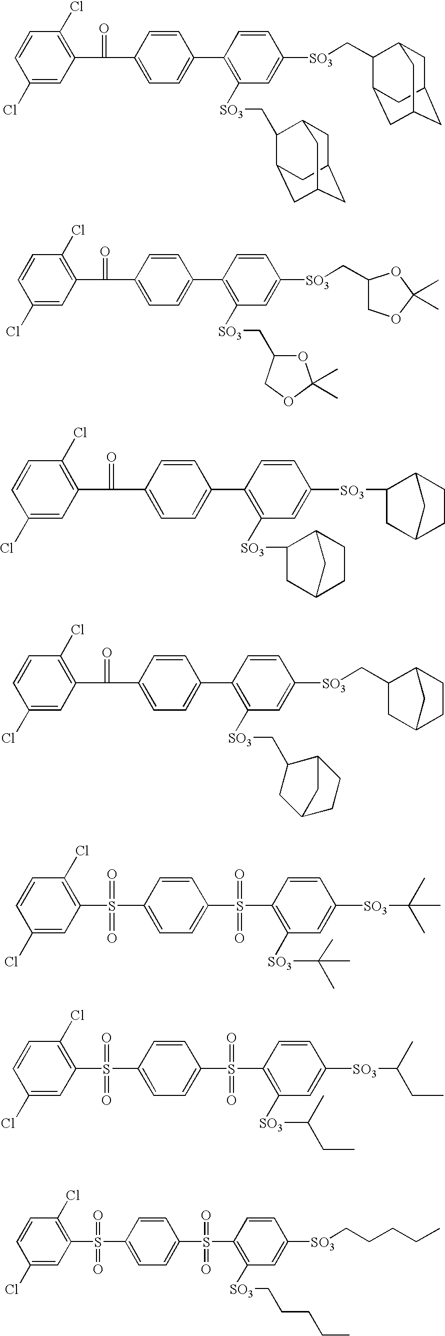

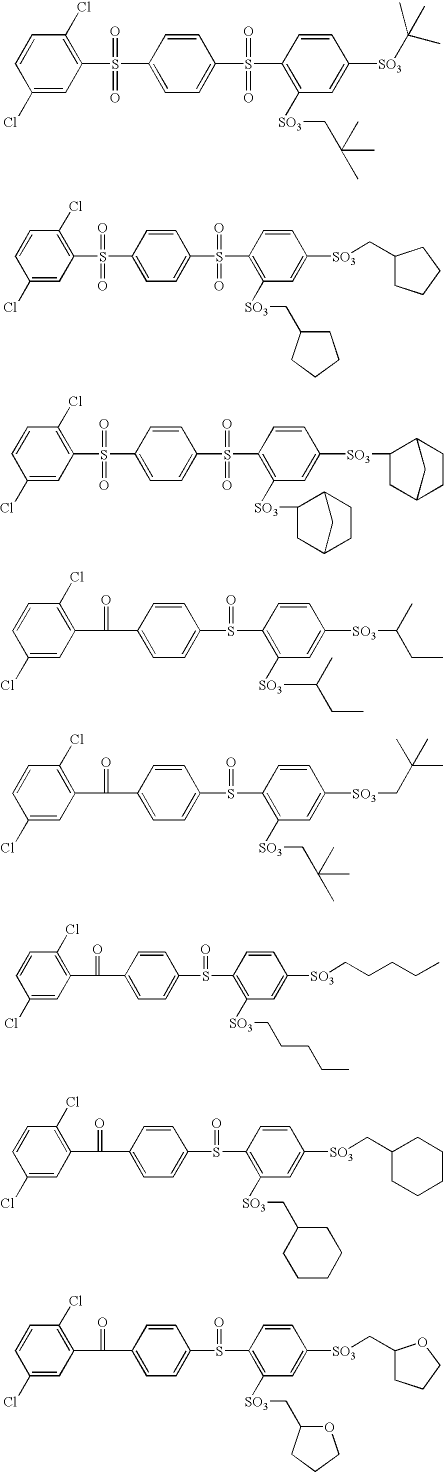

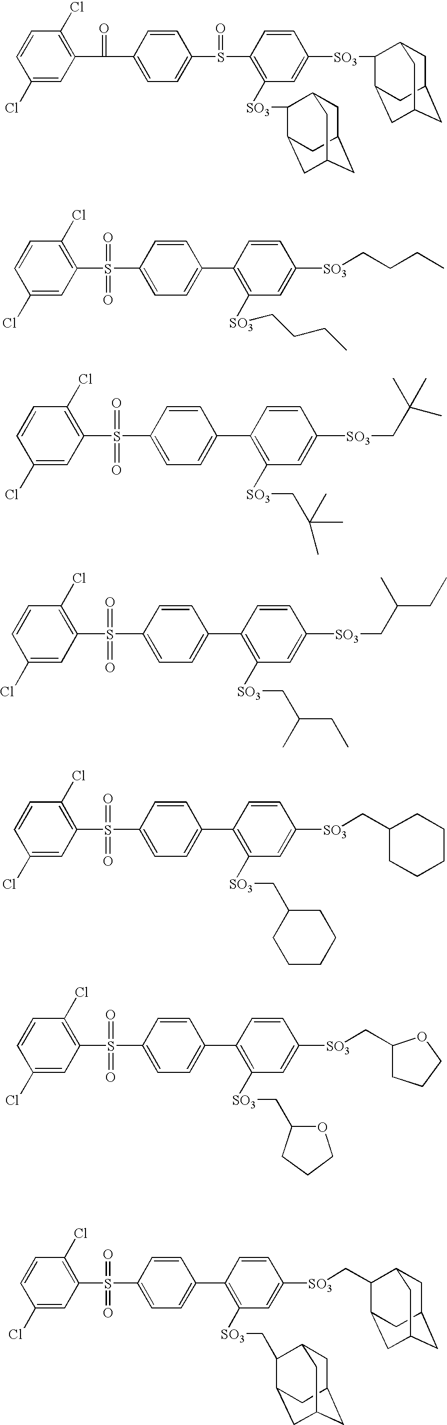

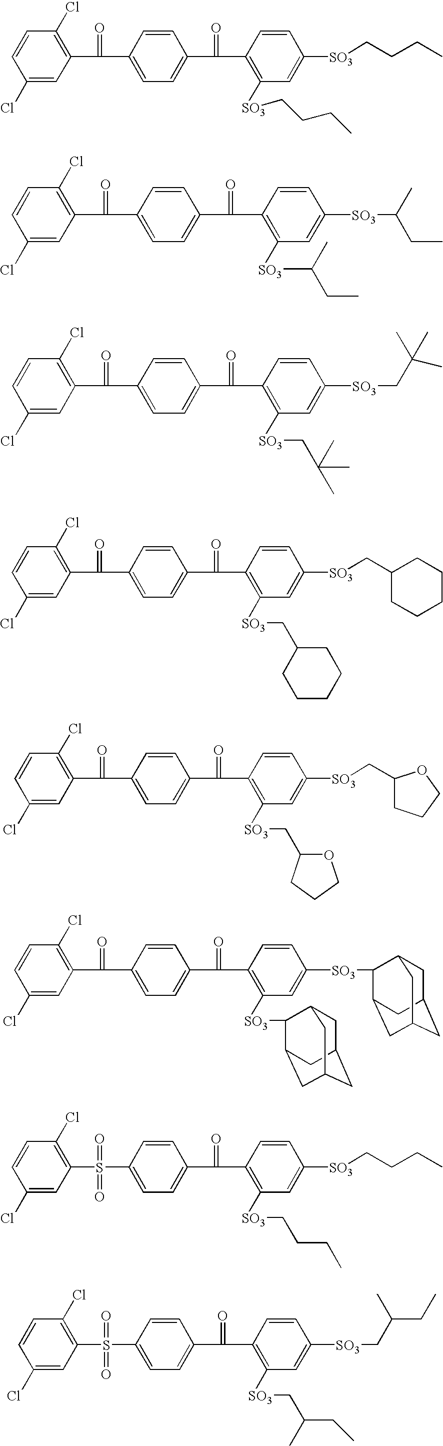

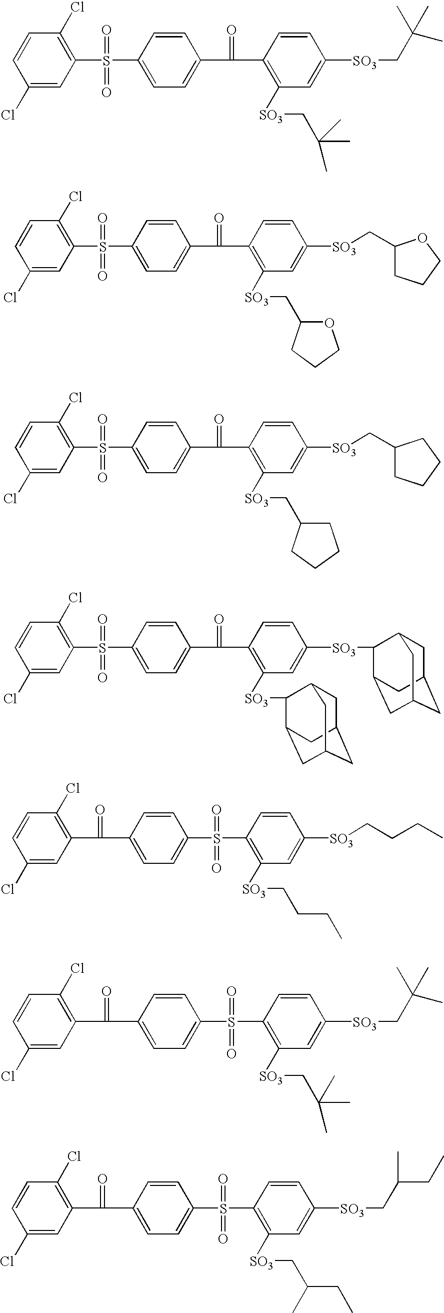

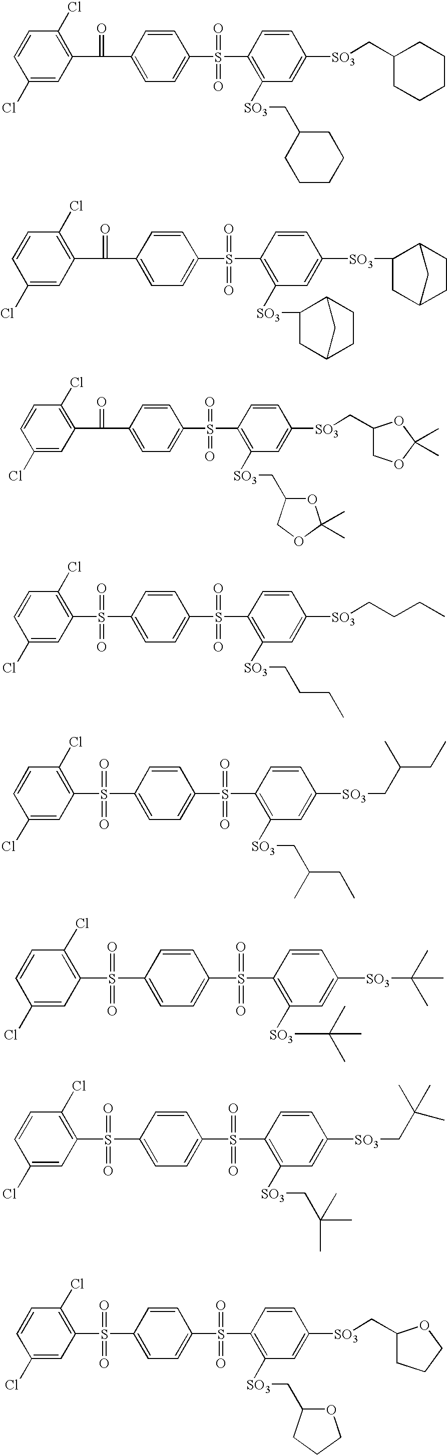

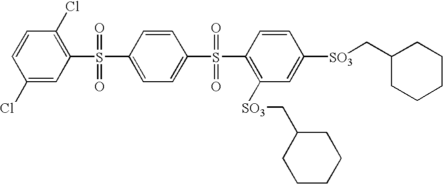

Also, as the aromatic sulfonic ester expressed by the above general formula (1), examples include compounds in which a chlorine atom is substituted for a bromine atom or an iodine atom in each of the above exemplified compounds. Moreover, the examples include compounds in which a chlorine atom is substituted for —OSO₂CH₃ or —OSO₂CF₃ in each of the above-exemplified compounds.

A method of synthesizing such an aromatic sulfonic ester is not limited in particular as long as the method can synthesize a compound expressed by the above general formula (1). However, when, after synthesizing a main skeleton, a plurality of sulfonic ester groups are introduced by utilizing a method using a sulfonating agent or the like, it is difficult to restrict the introduction location in many cases. Therefore, in order to synthesize the aromatic sulfonic ester to be used in the present invention, a method is preferable in which aromatic ring moiety having a plurality of sulfonic ester groups is synthesized beforehand, and it is then subjected to a coupling reaction with a structure constituting a particular main chain moiety. Specifically, the following method is preferable.

As for the synthesis of the aromatic ring moiety having a plurality of sulfonic ester groups, halogenated benzene is sulfonated by a generally known method, and thus obtained sulfonated benzene is protected by a protecting group, thereby resulting in halogenated benzenesulfonic ester. At this time, it is possible to synthesize a skeleton into which a plurality of sulfonic acid groups are introduced, by adjusting conditions such as a type of sulfonating agent, temperature and the like.

It is preferable to use a benzene ring for the aromatic ring moiety having a plurality of sulfonic ester groups. Because a plurality of sulfonyl groups are introduced into one ring, electron density of the ring is reduced, therefore an effect of suppressing the elimination of the sulfonic acid can also be expected. The synthesis is similarly possible by using various kinds of polycyclic aromatic compound such as naphthalene or anthracene, but control of the introduction location of the intramolecular sulfonic ester group is difficult. In addition to problems such as reduction of yield in synthesis, this causes a problem that the effect of densifying sulfonic acid is reduced because the ring structure or the molecule itself becomes too large.

A skeleton constituting the main chain moiety is a main skeleton such as benzophenone, diphenyl sulfoxide and diphenyl sulfone, in which one phenyl group has two halogen groups other than fluorine which are necessary for polymerization, while another phenyl group has functional groups for coupling with the skeleton into which the plurality of sulfonic acid groups have been introduced. As a functional group to be used for coupling, halogen, a mercapto group, boronic acid and the like can be used, and it is preferable to use a functional group that is different from the halogen group in the main chain to be used for polymerization in order to obtain a specified product in good yield. Specifically, when the functional group, which has been substituted to the aromatic ring forming a main chain at the time of polymerization, is chlorine, it is possible to use bromine, iodine, boronic acid and the like.

A generally known synthesis method can be used for synthesizing this skeleton. Specific examples include: a method in which a Friedel-Crafts reaction via benzoyl chloride is utilized; and a method in which an oxidization reaction by peroxide to a sulfinyl group or a sulfonyl group via thioetherification by means of a nucleophilic substitution reaction of phenyl thiol and phenyl fluoride.

A generally known method can be used for coupling a main chain moiety and an aromatic ring moiety having a plurality of sulfonic ester groups obtained as described above. For example, halogenated benzene having a sulfonic ester group is treated with a metal such as zinc to convert into an organometallic compound. In this case, a metal having a moderate activity such as zinc or indium is preferable, since metals having a high activity such as magnesium or lithium react with protected sulfonic ester. Subsequently, it is possible to obtain an intended aromatic sulfonic ester by a cross-coupling reaction with a main chain moiety by using a palladium catalyst or a nickel catalyst.

The obtained aromatic sulfonic ester is purified if necessary. As a method of identifying aromatic sulfonic ester, methods such as well-known NMR are adopted, but it is not limited thereto.

### [Sulfonated Polyarylene]

Sulfonated polyarylene used for the present invention is characterized by having a constitutional unit expressed by the following general formula (1′).

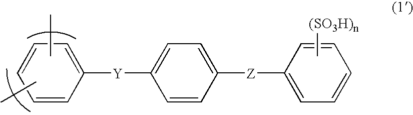

In the formula (1′), Y represents —CO— or —SO₂—, and preferably —CO—. Z represents a direct bond, —CO—, —SO₂— or SO—, and preferably a direct bond. n represents an integer of 2 to 5, and preferably 2 or 3.

The sulfonated polyarylene used for the present invention may be a sulfonated polyarylene polymer of a single constitutional unit expressed by the above general formula (1′), but it is preferable to be a copolymer including a constitutional unit expressed by the following general formula (2). It is possible to improve strength and water resistance of sulfonated polyarylene copolymer by including such a constitutional unit.

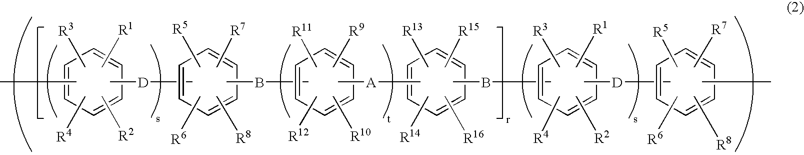

In the formula (2), A and D each independently represent at least one structure selected from the group consisting of a direct bond, —O—, —S—, —CO—, —SO₂—, —SO—, —CONH—, —COO—, —(CF₂)ᵢ— (i is an integer of 1 to 10), —(CH₂)ⱼ— (j is an integer of 1 to 10), —CR′₂—(R′ represents an aliphatic hydrocarbon group, aromatic hydrocarbon group, or halogenated hydrocarbon group), a cyclohexylidene group, and a fluorenylidene group. Among these, a direct bond, —O—, —CO—, —SO₂—, —CR′₂—, a cyclohexylidene group and a fluorenylidene group are preferable. Examples of R′ include methyl, ethyl, propyl, isopropyl, butyl, isobutyl, t-butyl, hexyl, octyl, decyl, octadecyl, ethylhexyl, phenyl, trifluoromethyl groups, and these substituents in which hydrogen atoms of these groups are partially or fully halogenated.

In the formula (2), B independently represents an oxygen or sulfur atom, and among these, an oxygen atom is preferred. R1 to R16 may be identical or different from each other, and represent at least an atom or a group selected from the group consisting of a hydrogen atom, fluorine atom, alkyl group, partially or fully halogenated alkyl group, allyl group, aryl group, nitro group and nitrile group. Examples of the alkyl group include methyl, ethyl, propyl, butyl, amyl, hexyl, cyclohexyl, octyl groups, and the like. Examples of the halogenated alkyl group include trifluoromethyl, pentafluoroethyl, perfluoropropyl, perfluorobutyl, perfluoropentyl, perfluorohexyl groups, and the like. Examples of the allyl group include a propenyl group; and examples of the aryl group include phenyl, pentafluorophenyl groups, and the like.

Further, in the formula (2), s and t each independently represent an integer of 0 to 4. R represents an integer of 0 or not less than 1, in which the upper limit is usually 100. Preferably, r is an integer of 1 to 80.

Examples of a preferred structure of the constitutional unit expressed by the above general formula (2) include the structures in which:

(i) s=1, t=1; A is —CR′₂—, a cyclohexylidene group or a fluorenylidene group; B is an oxygen atom; D is —CO— or —SO₂—; and R¹ to R¹⁶ are a hydrogen or fluorine atom;

(ii) s=1, t=0; B is an oxygen atom; D is —CO— or —SO₂—; and R¹ to R¹⁶ are a hydrogen or fluorine atom;

(iii) s=0, t=1; A is —CR′₂—, a cyclohexylidene group or a fluorenylidene group; B is an oxygen atom; and R¹ to R¹⁶ are a hydrogen atom, a fluorine atom or a nitrile group.

A monomer or oligomer which can be the constitutional unit expressed by the above general formula (2) can be synthesized as described later, for example, by referring to the method described in Japanese Unexamined Patent Application Publication No. 2004-137444.

### [Method for Producing Sulfonated Polyarylene]

The sulfonated polyarylene to be used for the present invention can be synthesized, for example, by the method described in Japanese Unexamined Patent Application Publication No. 2004-137444. Specifically, the aromatic sulfonic ester expressed by the above general formula (1), and the compound expressed by the following general formula (2′) which is a precursor of the constitutional unit expressed by the above general formula (2) are first copolymerized in the presence of a catalyst to prepare polyarylene having a sulfonic ester group; then the sulfonic ester group is de-esterified to convert it into a sulfonic acid group; whereby the intended product can be synthesized.

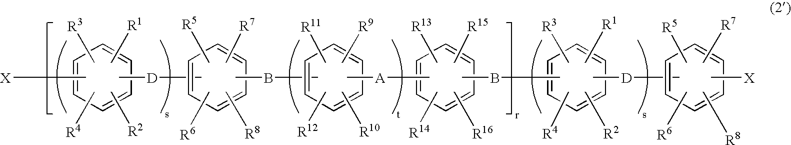

In the formula (2′), X represents an atom or a group selected from the group consisting of a halogen atom other than fluorine, i.e., a chlorine, bromine or iodine atom, —OSO₂CH₃ and —OSO₂CF₃, and chlorine or bromine is preferable. The definitions of A, B, D, R¹-R¹⁶, s, t, and r are the same as those of A, B, D, R¹-R¹⁶, s, t, and r in the above general formula (2).

The catalyst used in the abovementioned polymerization may be a catalyst system which contains a transition metal compound. Such a catalyst system essentially contains: (i) a transition metal salt and a ligand compound (hereinafter, may be referred to as “ligand component”), or a transition metal complex having a coordinated ligand (including copper salt); and (ii) a reducing agent, and additionally an optional “salt” in order to increase the polymerization reaction rate.

As for specific examples of the catalyst components, the usage ratio of each component, solvents, concentration, temperature, time period and the like in the reaction, those compounds and conditions illustrated in Japanese Unexamined Patent Application Publication No. 2001-342241 may be referred to for use or setting.

The ion-exchange capacity of the sulfonated polyarylene prepared in accordance with the method described above is usually 0.3 to 5 meq/g, preferably 0.5 to 4 meq/g, and more preferably 0.8 to 3.5 meq/g. When the ion-exchange capacity is less than the abovementioned range, the power generation performance tends to be insufficient due to lower proton conductivity. On the other hand, when the ion-exchange capacity is more than the abovementioned range, the water resistance tends to be remarkably degraded. However, by using sulfonated polyarylene having a constitutional unit expressed by the above general formula (1), it is possible to remarkably increase the ion-exchange capacity as compared to the case where the conventional monosulfonated monomer is used.

The ion-exchange capacity can be controlled, for example, by selecting the type, usage ratio, combination and the like of the compounds respectively expressed by the above general formulae (1) and (2′). The sulfonated polyarylene used in the present invention contains 0.5 to 100% by mole, preferably 10 to 99.999% by mole of the constitutional unit expressed by the above general formula (1′), and contains 0 to 99.5% by mole, preferably 0.001 to 90% by mole of the constitutional unit expressed by the above general formula (2).

The average mass molecular weight of the resulting sulfonated polyarylene is 10,000 to 1,000,000, preferably 20,000 to 500,000, and more preferably 100,000 to 400,000 based on a polystyrene standard by way of gel permeation chromatography (GPC). Since the sulfonated polyarylene having such a molecular weight has high proton conductivity, it is preferably used as an electrolyte for a proton conductive membrane-electrode and a binder for fuel cells. Also, the solid polymer electrolyte including such sulfonated polyarylene is preferably used as a membrane-electrode assembly.

### [Solid Polymer Electrolyte]

The solid polymer electrolyte used for preparing the proton conductive membrane of the membrane-electrode assembly for solid polymer electrolyte fuel cells according to the present invention contains the aforementioned sulfonated polyarylene. The solid polymer electrolyte used in the present invention may include an antioxidant such as a phenolic-hydroxide-group-containing compound, amine compound, organic phosphorous compound, or organic sulfur compound, within a range that does not deteriorate the proton conductivity. The solid polymer electrolyte can be used in various forms such as granular, fiber and membrane types, depending on the intended use. When the solid polymer electrolyte is used for the solid polymer electrolyte fuel cells, the form is preferably a membrane type (proton conductive membrane).

### [Proton Conductive Membrane]

The proton conductive membrane provided to the membrane-electrode assembly for solid polymer electrolyte fuel cells according to the present invention is prepared and formed into a membrane by using the solid polymer electrolyte containing the sulfonated polyarylene polymer. In addition, when the proton conductive membrane is prepared, an inorganic acid such as sulfuric acid or phosphoric acid, an organic acid including carboxylic acid, and an appropriate amount of water may be used in combination in addition to the solid polymer electrolyte.

Specifically, the proton conductive membrane can be produced by forming a film using a casting process or the like in which the sulfonated polyarylene is dissolved in a solvent to give a solution, and then the solution is poured over a substrate to form a film. The substrate which can be used herein is not particularly limited as long as it is a substrate utilized in conventional solution casting processes: for example, the substrate may be of plastics or metals, preferably of thermoplastic resins such as polyethylene terephthalate (PET) film.

Examples of the solvent for dissolving the sulfonated polyarylene include aprotic polar solvents such as N-methyl-2-pyrrolidone, N,N-dimethylformamide, γ-butyrolactone, N,N-dimethylacetamide, dimethylsulfoxide, dimethylurea and dimethylimidazolizinone. Among these, N-methyl-2-pyrrolidone (hereinafter also referred to as “NMP”) is preferable from the viewpoint of solubility and solution viscosity. These aprotic polar solvents may be used alone or in combination.

In addition, the solvent used to dissolve the sulfonated polyarylene can be a mixture of the aprotic polar solvent and an alcohol. Examples of the alcohol include methanol, ethanol, propyl alcohol, isopropyl alcohol, sec-butyl alcohol tert-butyl alcohol, and the like. Among these, methanol is preferred since it can reduce the solution viscosity over a wider range of compositions. These alcohols may be used alone or in combination.

When the mixture of the aprotic polar solvent and the alcohol is employed as the solvent, the content of the aprotic polar solvent is 25 to 95% by weight, preferably 25 to 90% by weight, and the content of the alcohol is 5 to 75% by weight, preferably 10 to 75% by weight, with the provision that the total is 100% by weight. The amount of the alcohol within the above range may have a favorable effect on decreasing the solution viscosity.

Although the concentration of the polymer in the solution including the dissolved sulfonated polyarylene may depend on the molecular weight of the sulfonated polyarylene, typically the concentration of the polymer is 5 to 40% by weight, preferably 7 to 25% by weight. When the polymer concentration is less than 5% by weight, to obtain a thicker membrane is difficult, and pinholes tend to occur. On the other hand, when the polymer concentration exceeds 40% by weight, the solution viscosity becomes too high to properly form a film, and the surface smoothness may also be deteriorated.

The solution viscosity is typically 2,000 to 100,000 mPa·s, and preferably 3,000 to 50,000 mPa·s, although it may depend on the molecular weight and the polymer concentration of the sulfonated polyarylene. When the solution viscosity is less than 2,000 mPa·s, the retaining property of the solution is likely to be insufficient during the film-forming process, and thus the solution sometimes flows out of the substrate. When the solution viscosity exceeds 100,000 mPa·s, the viscosity is too high to extrude the solution from a die, and thus the film is difficult to produce by means of flowing processes.

After the film formation as described above, the resulting non-dried film is immersed into water, whereby the organic solvent in the non-dried film can be replaced with water, and the residual solvent can be reduced within the obtained proton conductive membrane. Following the film formation, the non-dried film may be pre-dried before immersing it into water. The pre-drying is typically carried out by incubating at 50 to 150° C. for 0.1 to 10 hours.

The non-dried film may be immersed into water in a batch-wise method in which each film is immersed, or a in a continuous method in which a usually obtained intact laminate film formed on a substrate film (e.g., PET) or a membrane separated from the substrate is immersed into water and wound up successively. In the batch method, since the processed film is fitted into a frame, there is an advantage of preventing wrinkles on the surface of the processed film.

The contact ratio of water utilized for immersing the non-dried film may be no less than 10 parts, preferably no less than 30 parts by mass based on one part by mass of the non-dried film. To reduce the amount of a residual solvent within the obtained proton conductive membrane to as little as possible, it is preferable that the contact ratio be maintained as much as possible. Furthermore, the control of the concentration of the organic solvent in water at or below a certain level is effective to reduce the solvent that remains within the resulting proton conductive membranes. Such a control may be performed in a way that the water used for immersion is exchanged or overflowed properly, for example. Furthermore, the concentration of the organic solvent in the water is effectively homogenized by stirring, for example, in order to minimize the two-dimensional distribution of residual organic solvent within the proton conductive membrane.

The temperature of the water, in which the non-dried film is immersed, is preferably 5 to 80° C. The higher temperature accelerates the rate of replacing the organic solvent with water; however, the surface condition of the proton conductive membrane may be deteriorated after drying since the amount of water absorbed into the film tends to increase with the higher temperature. In general, the temperature of the water falls within the range of preferably 10 to 60° C. from the viewpoint of replacement rate and ease of handling. The immersion period depends on the initial content of the residual solvent, contact ratio, and processing temperature. However, the immersion period is typically 10 minutes to 240 hours, preferably 30 minutes to 100 hours.

When the non-dried film is dried after being immersed in water, the proton conductive membrane may be obtained with a lowered residual solvent content. The content of the residual solvent in the proton conductive membrane obtained in such a process is usually 5% by mass or less.

Depending on the immersion condition, the content of the residual solvent in the obtained proton conductive membrane can be decreased to 1% by mass or less. For example, such a condition may be provided by a method in which: the contact ratio of the non-dried film to water is 50 parts by mass or more based on 1 part by mass of the non-dried film; the water temperature is 10 to 60° C. at the time of immersion; and the immersion period is 10 minutes to 10 hours.

After immersing the non-dried film into water as described above, the film is dried at 30 to 100° C., preferably at 50 to 80° C. for 10 to 180 minutes, preferably for 15 to 60 minutes, then is vacuum dried at 50 to 150° C., under reduced pressure of preferably 500 mmHg to 0.1 mmHg for 0.5 to 24 hours, whereby the proton conductive membrane may be obtained. The thickness of the proton conductive membrane obtained by the method of the present invention is typically 10 to 100 μm, preferably 20 to 80 μm in the dried condition.

In the present invention, it is also possible to produce a proton conductive film containing sulfonated polyarylene by forming the sulfonated polyarylene is into a film as described above without hydrolyzing the sulfonated polyarylene, and then hydrolyzing the resulting film as described above.

The proton conductive membrane for use in the present invention may contain an antioxidant, preferably a hindered phenolic compound having a molecular weight of no lower than 500. By containing an antioxidant, the durability as a proton conductive membrane can be improved.

Specific examples of the hindered phenolic compound having a molecular weight of no lower than 500, which may be used in the present invention, include triethylene glycol bis[3-(3-t-butyl-5-methyl-4-hydroxyphenyl)propionate (product name: IRGANOX 245), 1,6-hexanediol bis[3-(3,5-di-t-butyl-4-hydroxyphenyl)propionate] (product name: IRGANOX 259), 2,4-bis-(n-octylthio)-6-(4-hydroxy-3,5-di-t-butylanilino)-3,5-triazine (product name: IRGANOX 565), pentaerythrityl-tetrakis[3-(3,5-di-t-butyl-4-hydroxyphenyl)propionate] (product name: IRGANOX 1010), 2,2-thio-diethylenebis[3-(3,5-di-t-butyl-4-hydroxyphenyl)propionate] (product name: IRGANOX 1035), octadecyl-3-(3,5-di-t-butyl-4-hydroxyphenyl)propionate] (product name: IRGANOX 1076), N,N-hexamethylene bis(3,5-di-t-butyl-4-hydroxy-hydrocinnamamide) (product name: IRGANOX 1098), 1,3,5-trimethyl-2,4,6-tris(3,5-di-t-butyl-4-hydroxybenzyl)benzene (product name: IRGANOX 1330), tris-(3,5-di-t-butyl-4-hydroxybenzyl)-isocyanurate (product name: IRGANOX 3114), 3,9-bis[2-[3-(3-t-butyl-4-hydroxy-5-methylphenyl)propionyloxy]-1,1-dimethylethyl]-2,4,8,10-tetraoxaspiro[5.5]undecane (product name: Sumilizer GA-80), and the like.

In the present invention, the hindered phenolic compound having a molecular weight of no lower than 500 is preferably used in an amount of 0.01 to 10 parts by mass based on 100 parts by mass of the polyarylene copolymer.

The proton conductive membrane of the present invention can be preferably used as a proton conductive membrane in, for example, electrolytes for primary cells and secondary cells, polymer solid electrolytes for fuel cells, display devices, a variety of sensors, signal transfer media, solid condensers, ion exchange membranes, and the like. Particularly, the proton conductive membrane is preferably used as a proton conductive membrane for a membrane-electrode assembly for solid polymer electrolyte fuel cells.

### [Electrode]

The electrode of the membrane-electrode assembly for solid polymer electrolyte fuel cells according to the present invention includes catalyst metal particles or an electrode catalyst having a conductive carrier on which catalyst metal particles are supported, and an electrode-electrolyte. Further, other component such as carbon fiber, a dispersant, and a water repellent may be included if necessary.

The catalyst metal particles are not particularly limited so long as they have a catalytic activity, and a metal black consisting of fine noble metal particles themselves, such as a platinum black, can be used. The conductive carrier on which catalyst metal particles are supported is not particularly limited so long as it has conductivity and appropriate anticorrosion characteristics, and the conductive carrier including carbon as a main component is preferably used since carbon has sufficient specific surface area for highly dispersing the catalyst metal particles and sufficient electronic conductivity. The catalyst carrier constituting the electrode not only supports the catalyst metal particles, but also serves a function as an electric collector for collecting electrons into or from an external circuit. The higher the electric resistance the catalyst carrier has, the higher the internal resistance of a cell becomes, which results in lowering the performance of the cell. Therefore, the electronic conductivity of the catalyst carrier contained in the electrode must be sufficiently high. In other words, an electrode catalyst carrier can be used when it has a sufficient electronic conductivity, and porous carbon material may be preferably used. Carbon blacks or activated carbons may be preferably used as the porous carbon material. Examples of the carbon black include channel blacks, furnace blacks, thermal blacks, acetylene blacks and the like. The activated carbon may be obtained through carbonizing and activating various carbon-containing materials. In addition, a metal oxide, metal carbide, metal nitride, and polymer compound having electronic conductivity can be contained. In addition, the “main component” referred to herein means to contain a carbonaceous material accounting for no less than 60%.

In addition, platinum or a platinum alloy is used in the catalyst metal particles supported on the conductive carrier, and stability and activity as the electrode catalyst can be further imparted when a platinum alloy is used. Preferably, a platinum alloy is used which is formed from platinum and at least one metal selected from platinum group metals other than platinum (i.e., ruthenium, rhodium, palladium, osmium and iridium), and metals of other groups such as cobalt, iron, titanium, gold, silver, chromium, manganese, molybdenum, tungsten, aluminum, silicon, rhenium, zinc and tin. The platinum alloy may include an intermetallic compound which is formed of platinum and other metals alloyable with platinum.

Preferably, the supported content of platinum or the platinum alloy (i.e., % by mass of platinum or platinum alloy on the basis of the overall mass of supported catalyst) is 20 to 80% by mass, and in particular 30 to 55% by mass. The supported content in this range may afford higher output power. However, when the supported content is less than 20% by mass, sufficient output power may not be attained, and when it exceeds 80% by mass, the particles of platinum or the platinum alloy may not be supported on the carbon material to be a carrier with sufficient dispersibility.

The primary particle size of the platinum or platinum alloy is preferably 1 to 20 nm so as to attain highly active gas diffusion electrodes; in particular, and the primary particle size is preferably 2 to 5 nm to ensure a larger surface area of the platinum or platinum alloy from the viewpoint of reaction activity.

As the electrode-electrolyte, an ion conductive polymer electrolyte (ion conductive binder) having a sulfonic acid group is preferably used. Usually, the supported catalyst is covered with the electrolyte, and thus protons (H⁺) travel through the pathway of the connecting electrolyte.

A perfluorocarbon polymer, exemplified by Nafion (registered trademark), Flemion (registered trademark) and Aciplex (registered trademark), is appropriately used for the ion conductive polymer electrolyte containing a sulfonic acid group. A sulfonated product of a vinyl monomer such as polystyrene sulfonate, a polymer prepared by introducing a sulfonic acid group or phosphoric group in a heat-resistant polymer such as polybenzoimidazole or polyetheretherketone, or an ion conductive polymer electrolyte based on the aromatic hydrocarbon compounds, such as sulfonated polyarylene described herein, may be utilized in place of the perfluorocarbon polymer.

Preferably, the ion conductive binder is included in a mass ratio of 0.1 to 3.0, preferably 0.3 to 2.0 in particular, based on the mass of the catalyst particles. When the ratio of the ion conductive binder is less than 0.1, protons may not be transferred to the electrolyte, and thus possibly result in an insufficient power output. Meanwhile, when the ratio is more than 3.0, the ion conductive binder may cover the catalyst particles completely, and thus gas cannot reach the platinum, resulting in an insufficient power output.

As for the carbon fiber that can be added if necessary, rayon carbon fiber, PAN carbon fiber, lignin poval carbon fiber, pitch carbon fiber, vapor-phase grown carbon fiber or the like can be used. Among these, vapor-phase grown carbon fiber is preferred. When the carbon fiber is included, pore volume in the electrode catalyst layer is increased so that diffusibility of fuel gas or oxygen gas is improved, and flooding of generated water and the like can be improved to enhance power generation performance. In addition, the carbon fiber may be contained in the electrode catalyst layer on the anode side or the cathode side, or both.

The dispersant can include an anionic, cationic, ampholytic, nonionic surfactant, or the like. The dispersant may be used alone or in combination. Among these, a surfactant having a basic group is preferable, an anionic or cationic surfactant is more preferable, and a surfactant having a molecular weight of 5,000 to 30,000 is still more preferable. By adding the dispersant to the paste composition for the electrode used when the electrode catalyst layer is formed, preservation stability and flowability of the paste composition becomes superior, which improves productivity in coating.

The membrane-electrode assembly according to the present invention may be formed solely of an anodic catalyst layer, a proton conductive membrane, and a cathodic catalyst layer. It is more preferred that a gas diffusion layer formed of a conductive porous material such as carbon paper or carbon cloth be disposed outside both of the anodic and cathodic catalyst layers. The gas diffusion layer may also act as an electric collector, and therefore, the combination of the gas diffusion layer and the catalyst layer is herein referred to as an “electrode” when the gas diffusion layer is provided.

In a solid polymer electrolyte fuel cell equipped with the membrane-electrode assembly according to the present invention, oxygen-containing gas is supplied to the cathode and hydrogen-containing gas is supplied to the anode. Specifically, a separator having channels for the gas passage is disposed outside both electrodes of the membrane-electrode assembly, and the gas flows into the passage. Thus, the gas for fuel is supplied to the membrane-electrode assembly by allowing the gas to flow into the passage.

The method for producing the membrane electrode assembly of the present invention may be selected from various methods in which: a catalyst layer directly formed on an ion-exchange membrane and sandwiched with gas diffusion layers as required; a catalyst layer is formed on a substrate for a gas diffusion layer such as carbon paper, and the catalyst layer bonded with an ion-exchange membrane; and a catalyst layer is formed on a flat plate, which is detached after transferring the catalyst layer onto an ion-exchange membrane, and may be sandwiched with gas diffusion layers as required.

The method for forming the catalyst layer may be selected from conventional methods, in which the supported catalyst and a perfluorocarbon polymer having a sulfonic acid group are dispersed into a medium to prepare a dispersion to which a water repellent agent, pore-forming agent, thickener, diluent solvent and the like may be optionally added, and then the dispersion is used to form the catalyst layer on the ion-exchange membrane, the gas-diffusion layer or the flat plate.

Examples of the method for forming the electrode paste composition include brush coating, writing brush coating, bar coater coating, knife coater coating, doctor blade method, screen printing, spray coating, and the like.

In cases in which a catalyst layer is not formed on the ion-exchange layer directly, the catalyst layer and the ion-exchange layer are preferably bonded by means of a hot press or adhesion process, etc. (see, Japanese Unexamined Patent Application Publication No. Hei 07-220741).

### EXAMPLES

The present invention will be explained more specifically with reference to Examples, which are not intended to limit the scope of the present invention. The methods or ways to determine various measurements in the Examples are also illustrated in the following.

### Molecular Weight

Molecular weight of sulfonated polyarylene was determined by GPC in terms of the mass average molecular weight based on a polystyrene standard. GPC measurement solvent employed was N-methyl-2-pyrrolidone to which lithium bromide was added.

### Ion Exchange Capacity

The resulting sulfonated polyarylene was washed until the pH of the wash water became 4 to 6, so as to remove free residual acid, and was then sufficiently washed and dried. The polyarylene was then weighed in a predetermined amount, and dissolved in a mixed solvent of THF/water, then the solution was titrated with a NaOH standard solution, using phenolphthalein as an indicator, whereby the ion exchange capacity was determined from the neutralization point.

### Proton Conductivity

Alternating-current resistance was determined by pushing five platinum wires of 0.5 mm diameter onto the surface of the test membrane which is formed into a strip shape (40 mm×5 mm) at an interval of 5 mm, keeping the test sample in a controlled temperature/humidity chamber (“JW241” produced by Yamato Scientific Co., Ltd.) and then measuring AC impedance between the platinum wires. The determination was performed using Chemical Impedance Measuring System (by NF Corporation) as a resistance measurement system for AC 10 kHz under conditions of 85° C. and a varying relative humidity, with a varying conductor spacing of 5 to 20 mm. The specific resistance R of the membrane was then calculated from the slope of the relationship between conductor spacing and resistance according to the following formula (1), and then the proton conductivity was determined from the inverse value of the specific resistance R.

Specific resistance R(Ω·cm)=0.5 (cm)×membrane thickness (cm)×slope of relationship between conductor spacing and resistance (Ω/cm) (1)

### Water Resistance Test

First, the lengths of the long side and the short side of the test membrane cut into 2×3 cm were precisely measured. The test membrane was put into a heat resistant resin container, to which a sufficient amount of water was added. After sealing the container was airtight, an oven or a pressure cooker testing machine was used for heat-treatment at 95 and 120° C., respectively, for 24 hours. After completing the heating, the temperature was lowered to the ambient temperature by standing to cool. The test membrane was taken out, and water droplets on the surface were briefly wiped off. Thereafter, the length of each side, the membrane thickness, and the weight were measured. The water resistance of the sample was determined by using the obtained values in accordance with the following formula (2).

Rate of dimensional change (%)=(long side length after test (cm)/long side length before test (cm))+(short side length after test (cm)/short side length before test (cm))/2×100 (2)

### Evaluation of Power Generation Property

The membrane-electrode assembly according to the present invention was used to evaluate the power generation performance under the conditions of the temperature being 85° C., the relative humidity being 50%/50% and 100%/100% on a fuel electrode side/oxygen electrode side, and the current density being 1 A/cm². Pure hydrogen was supplied to the fuel electrode side, while the air was supplied to the oxygen electrode side. As the evaluation of the durability in power generation, the membrane-electrode assembly was used under the OCV condition at a temperature of 85° C. to perform a dry/wet cycle test in a range of the relative humidity of 0/0% RH to 100/100% RH, and the time until a cross leakage occurs was measured. Cases where the time until a cross leak occurs corresponded to no less than 5000 cycles were considered to be superior and indicated as “o”, while cases where the time until a cross leakage occurs corresponded to less than 5000 cycles were considered to be inferior and indicated as “x”.

### Example 1

### (1) Synthesis of bromobenzene-2,4-disulfonic acid neopentyl

186 g (1.2 mol) of chlorosulfonic acid was charged in a nitrogen atmosphere into a four-necked flask equipped with a dropping funnel, a thermometer and a Dimroth condenser, and 31.4 g (0.2 mol) of bromobenzene was dropped from the dropping funnel over 30 minutes while stirring. After allowing for the reaction at 120° C. for 6 hours, the reaction solution was poured into ice water, and then organic matters were extracted with ethyl acetate. After an organic layer was dried using magnesium sulfate, the solvent was removed using an evaporator to give 70 g of a crude product of bromobenzene-2,4-disulfonyl chloride.

118.9 g (1.5 mol) of pyridine and 17.4 g (0.198 mol) of 2,2-dimethyl-1-propanol were added into a three-necked flask, and cooled to 0° C. The crude product of sulfonyl chloride obtained as described above was gradually added to this solution. After allowing for the reaction for 4 hours while keeping the temperature at no higher than 5° C. in an ice bath, the ice bath was removed, and the temperature was gradually raised to the ambient temperature. The reaction solution was poured to 500 ml of an aqueous hydrochloric acid solution, and then organic matters were extracted with ethyl acetate. The resulting organic layer was washed with an aqueous hydrochloric acid water solution, a 5% sodium hydrogen carbonate solution, and then saturated saline. Thereafter, the organic layer was dried with magnesium sulfate. The solvent was removed using an evaporator, and the obtained crude product was recrystallized with an ethyl acetate/hexane solution to give 72 g crude crystals of the specified product.

### (2) Synthesis of 4-(2,5-dichlorobenzoyl)-benzene boronic acid-2,2-dimethyl-1,3-propanediol ester

300 ml of toluene was charged into a three-necked flask equipped with a Dean-Stark tube and a thermometer, and 115.5 g (0.35 mol) of 2,5-dichloro-4′-bromobenzophenone, 60.5 g (0.58 mol) of 2,2-dimethyl-1,3-propanediol, and 6.66 g (0.04 mol) of p-toluenesulfonic acid monohydrate were added thereto. The mixture was heated to reflux at 130° C., whereby the reaction was allowed while removing generated water. About 20 hours later, it was confirmed that a stoichiometric amount (about 6.3 g) of water had been recovered, and then the reaction solution was transferred to a 1 L beaker. The reaction solution was cooled in a salt ice bath, and the precipitated crystals were collected through filtration and rinsed with ethanol to give 120 g of white crystals.

500 ml of dehydrated tetrahydrofuran was charged in a nitrogen atmosphere into a three-necked flask, to which 41.2 g (0.1 mol) of the white crystals were added and dissolved, and the mixture was cooled to −75° C. in a dry ice/acetone bath. 10.5 ml (0.105 mol) of a 10M hexane solution of n-butylithium was slowly dropped thereinto using a syringe, and the mixture was reacted at −65° C. for 1 hour. Subsequently, 15.5 g (0.15 mol) of trimethyl borate was dropped thereinto, and the mixture was reacted at −60° C. for 1 hour. The cooling bath was then removed, and the temperature was gradually elevated to the ambient temperature. A hydrochloric acid solution was then added to the reaction solution, and the mixture was heated to 70° C. to permit the reaction. After cooling, acetone was added, and the mixture was stirred. The solvent was then removed by an evaporator, and precipitated crude crystals were collected through filtration. Recrystallization was performed with an ethyl acetate/hexane solution to give 23 g of white crystals of the specified product.

### (3) Synthesis of 4′-(2,5-dichlorobenzoyl)biphenyl-2,4-disulfonic acid neopentyl

77 ml of toluene was charged into a three-necked flask equipped with a Dimroth condenser and a thermometer, and 14.0 g (0.03 mol) of bromobenzene-2,4-disulfonic acid neopentyl and 1.06 g (0.9 mmol) of tetrakis triphenylphosphine palladium were added thereto and the mixture was stirred. After 32 g of a 2 mol/l aqueous potassium carbonate solution was added thereto, 16 ml of ethanol, into which 4-(2,5-dichlorobenzoyl)-benzene boronic acid-2,2-dimethyl-1,3-propanediol ester had been dispersed, was added thereto, and the mixture was reacted with heating to reflux for six hours. 1.8 g of a 30% hydrogen peroxide solution was added to the reaction solution, followed by stirring for 1 hour. Ethyl acetate was added to the reaction solution, and the solution was extracted. The resulting organic layer was washed with water and then with saturated saline, and then dried with magnesium sulfate. The solvent was removed with an evaporator, and the resulting crude crystals were recrystallized with an acetone/hexane solution to give 12 g of the specified product with a structure expressed by the following formula (I).

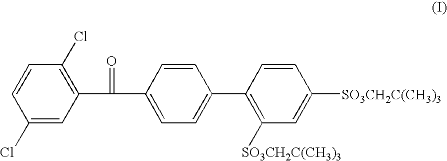

### (4) Synthesis of sulfonated polyarylene

54.5 g (86.8 mmol) of sulfonic acid neopentyl obtained as described above, 34.3 g (3.2 mmol) of a hydrophobic unit represented by the following structural formula (II), 1.77 g (3.0 mmol) of bis(triphenylphosphine)nickel dichloride, 0.41 g (2.7 mmol) of sodium iodide, 9.44 g (36.0 mmol) of triphenylphosphine and 14.1 g (216 mmol) of zinc were weighed into a 1 L three-necked flask equipped with a stirrer, a thermometer and a nitrogen inlet tube, and the mixture was purged with a dry nitrogen gas. Thereto was added 270 mL of N,N-dimethylacetamide (DMAc), and the reaction mixture was kept stirring while maintaining the reaction temperature at 80° C. for 3 hours. Then the reaction mixture was diluted with 480 mL of DMAc, and insoluble matter was filtered off.

The resulting solution was charged into a 2 L three-necked flask equipped with a stirrer, a thermometer and a nitrogen inlet tube. The resulting mixture was stirred while heating at 115° C., and 23 g (260 mmol) of lithium bromide was added thereto. After stirring for 7 hours, the mixture was poured into 7 L of deionized water to precipitate the product. The precipitate was washed with acetone, 1 N HCl and pure water in this order, and then dried to obtain the intended polymer of 70 g. The mass average molecular weight (Mw) of the resulting polymer was 235,000. Therefore, the resulting polymer was presumed to be the sulfonated polyarylene expressed by the formula (III) The ion-exchange capacity of the polymer was 2.3 meq/g.

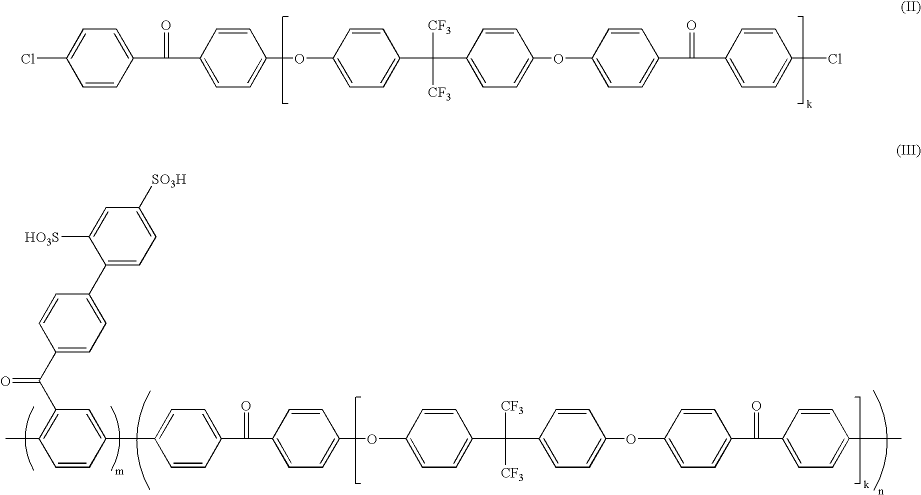

### Example 2

54.4 g (86.8 mmol) of sulfonic acid neopentyl obtained in Example 1, 34.3 g (4.2 mmol) of a hydrophobic unit (Mn=8,200) expressed by the following structural formula (IV), 2.38 g (3.6 mmol) of bis(triphenylphosphine) nickel dichloride, 0.41 g (2.7 mmol) of sodium iodide, 9.55 g (36.4 mmol) of triphenylphosphine and 14.3 g (218 mmol) of zinc were weighed into a 1 L three-necked flask equipped with a stirrer, a thermometer and a nitrogen inlet tube, and then the mixture was purged with a dry nitrogen gas. Thereto was added 270 mL of N,N-dimethylacetamide (DMAc), and the reaction mixture was kept stirring while maintaining the reaction temperature at 80° C. for 3 hours. Then the reaction mixture was diluted with 480 mL of DMAc, and insoluble matter was filtered off.

The resulting solution was charged into a 2 L three-necked flask equipped with a stirrer, a thermometer and a nitrogen inlet tube. The solution was stirred while heating at 115° C., and 23 g (260 mmol) of lithium bromide was added thereto. After stirring for 7 hours, the reaction mixture was poured into 7 L of deionized water to precipitate the product. The precipitate was washed with acetone, 1 N HCl and pure water in this order, and then dried to obtain the intended polymer of 70 g. The mass average molecular weight (Mw) of the resulting polymer was 235,000. Therefore, the resulting polymer was presumed to be the sulfonated polyarylene expressed by the formula (V). The ion-exchange capacity of the polymer was 2.3 meq/g.

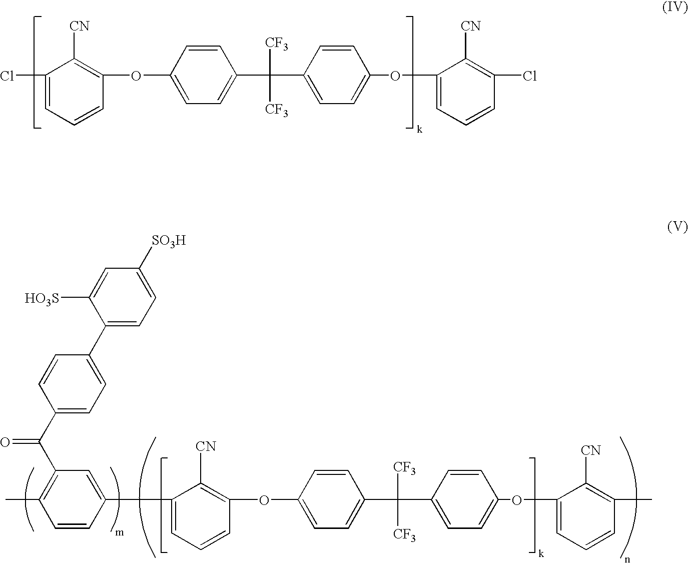

### Example 3

54.0 g (86.0 mmol) of sulfonic acid neopentyl obtained in Example 1, 35.6 g (4.0 mmol) of a hydrophobic unit (Mn=9,000) expressed by the following structural formula (VI), 2.36 g (3.6 mmol) of bis(triphenylphosphine) nickel dichloride, 0.40 g (2.7 mmol) of sodium iodide, 9.44 g (36.0 mmol) of triphenylphosphine and 14.1 g (216 mmol) of zinc were weighed into a 1 L three-necked flask equipped with a stirrer, a thermometer and a nitrogen inlet tube, and then the mixture was purged with a dry nitrogen gas. Thereto was added 290 mL of N,N-dimethylacetamide (DMAc), and the reaction mixture was kept stirring while maintaining the reaction temperature at 80° C. for 3 hours. Then the reaction mixture was diluted with 500 mL of DMAc, and insoluble matter was filtered off.

The resulting solution was charged into a 2 L three-necked flask equipped with a stirrer, a thermometer and a nitrogen inlet tube. The solution was stirred while heating at 115° C., and 22.4 g (258 mmol) of lithium bromide was added thereto. After stirring for 7 hours, the reaction mixture was poured into 7 L of deionized water to precipitate the product. The precipitate was washed with acetone, 1 N HCl and pure water in this order, and then dried to obtain the intended polymer of 68 g. The mass average molecular weight (Mw) of the resulting polymer was 250,000. Therefore, the resulting polymer was presumed to be the sulfonated polyarylene expressed by the formula (VII). The ion-exchange capacity of the polymer was 2.3 meq/g.

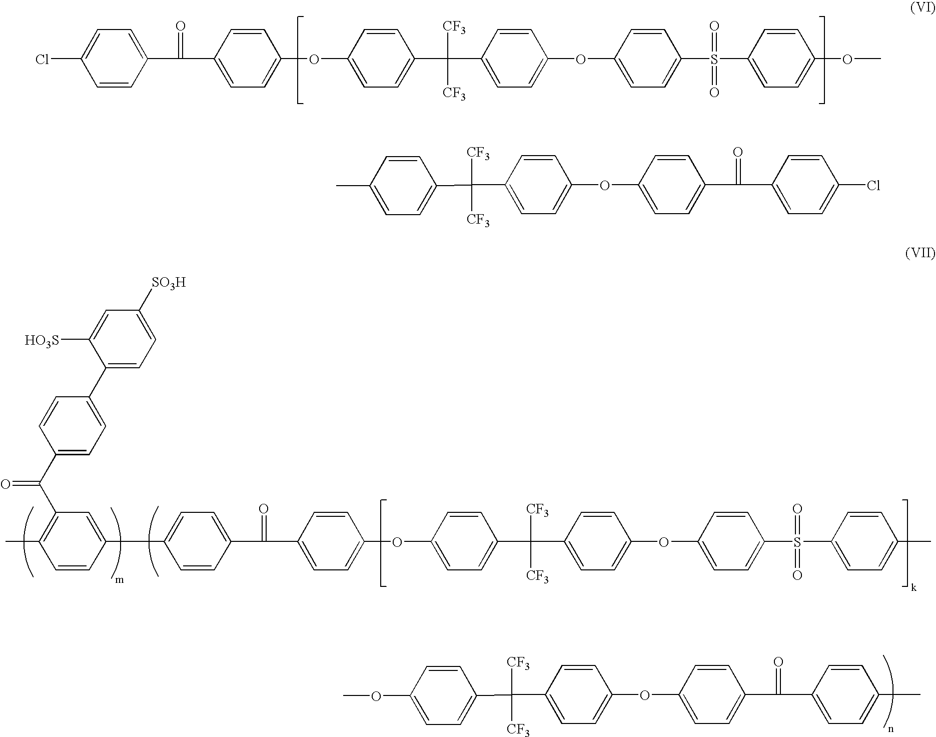

### Example 4

53.3 g (85.0 mmol) of sulfonic acid neopentyl obtained in Example 1, 35.6 g (5.0 mmol) of a hydrophobic unit (Mn=7,000) expressed by the following structural formula (VIII), 2.36 g (3.6 mmol) of bis(triphenylphosphine) nickel dichloride, 0.40 g (2.7 mmol) of sodium iodide, 9.44 g (36.0 mmol) of triphenylphosphine and 14.1 g (216 mmol) of zinc were weighed into a 1 L three-necked flask equipped with a stirrer, a thermometer and a nitrogen inlet tube, and then the mixture was purged with a dry nitrogen gas. Thereto was added 290 mL of N,N-dimethylacetamide (DMAc), and the reaction mixture was kept stirring while maintaining the reaction temperature at 80° C. for 3 hours. Then the reaction mixture was diluted with 500 mL of DMAc, and insoluble matter was filtered off.

The resulting solution was charged into a 2 L three-necked flask equipped with a stirrer, a thermometer and a nitrogen inlet tube. The solution was stirred while heating at 115° C., and 22.1 g (255 mmol) of lithium bromide was added thereto. After stirring for 7 hours, the mixture was poured into 7 L of deionized water to precipitate the product. The precipitate was washed with acetone, 1 N HCl and pure water in this order, and then dried to obtain the intended polymer of 68 g. The mass average molecular weight (Mw) of the resulting polymer was 250,000. Therefore, the resulting polymer was presumed to be the sulfonated polyarylene expressed by the formula (IX). The ion-exchange capacity of the polymer was 2.3 meq/g.

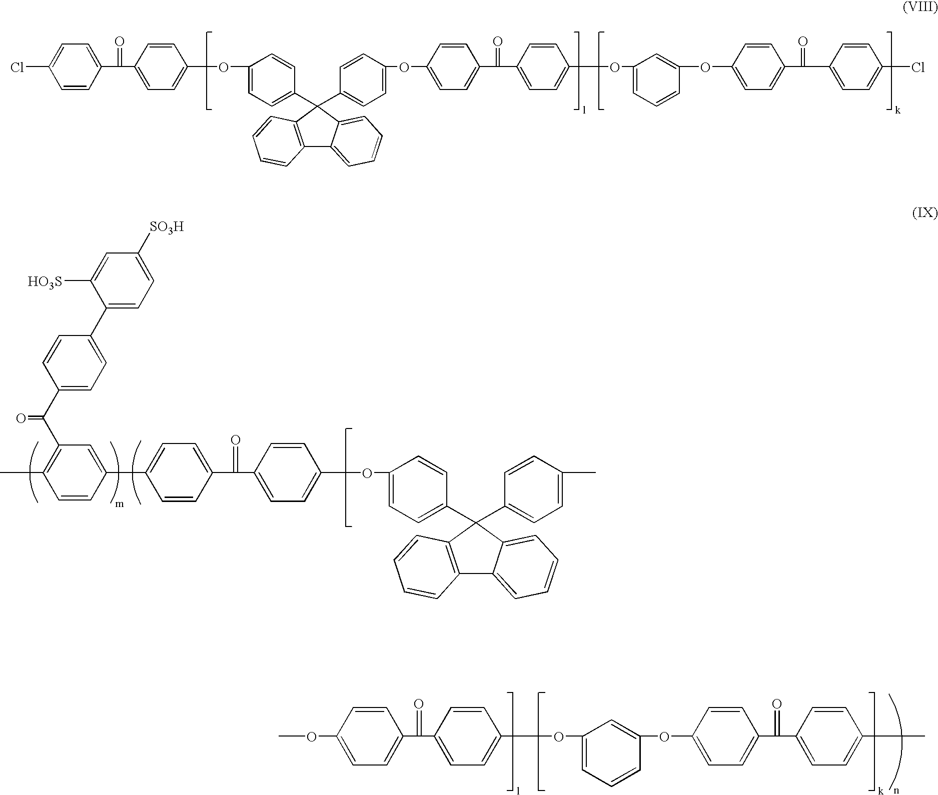

### Example 5

53.3 g (85.0 mmol) of sulfonic acid neopentyl obtained in Example 1, 35.6 g (5.0 mmol) of a hydrophobic unit (Mn=7,000) expressed by the following structural formula (X), 2.36 g (3.6 mmol) of bis(triphenylphosphine) nickel dichloride, 0.40 g (2.7 mmol) of sodium iodide, 9.44 g (36.0 mmol) of triphenylphosphine and 14.1 g (216 mmol) of zinc were weighed into a 1 L three-necked flask equipped with a stirrer, a thermometer and a nitrogen inlet tube, and then the mixture was purged with a dry nitrogen gas. Thereto was added 290 mL of N,N-dimethylacetamide (DMAc), and the reaction mixture was kept stirring while maintaining the reaction temperature at 80° C. for 3 hours. Then the reaction mixture was diluted with 500 mL of DMAc, and insoluble matter was filtered off.

The resulting solution was charged into a 2 L three-necked flask equipped with a stirrer, a thermometer and a nitrogen inlet tube. The solution was stirred while heating at 115° C., and 22.1 g (255 mmol) of lithium bromide was added thereto. After stirring for 7 hours, the reaction mixture was poured into 7 L of deionized water to precipitate the product. The precipitate was washed with acetone, 1 N HCl and pure water in this order, and then dried to obtain the intended polymer of 68 g. The mass average molecular weight (Mw) of the resulting polymer was 250,000. Therefore, the resulting polymer was presumed to be the sulfonated polyarylene expressed by the formula (XI). The ion-exchange capacity of the polymer was 2.3 meq/g.

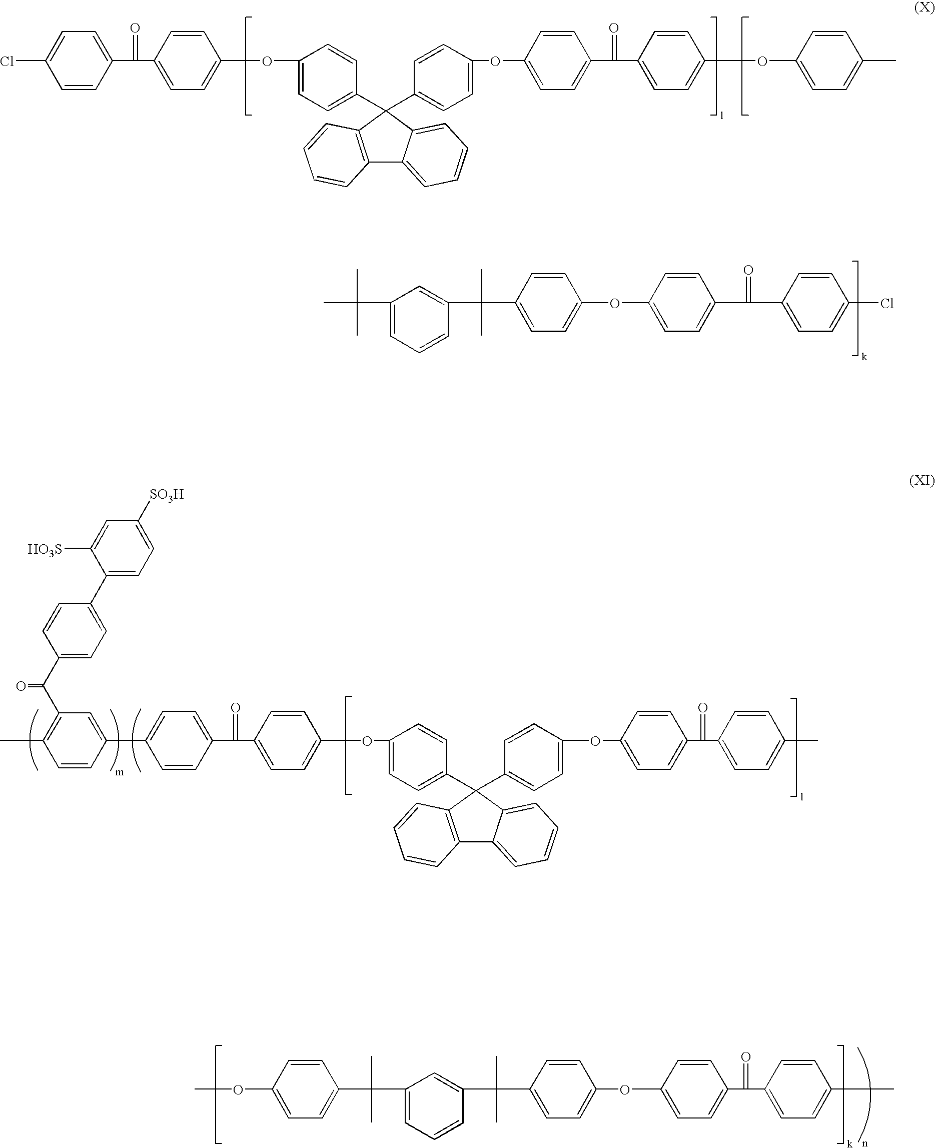

### Comparative Example 1

68.8 g (144 mmol) of 4′-(2,5-dichlorobenzoyl)-biphenyl-4-sulfonic acid neopentyl expressed by the following structural formula (XII), 11.0 g (1.0 mmol) of a hydrophobic unit (Mn=11,200) expressed by the above structural formula (II), 3.79 g (5.8 mmol) of bis(triphenylphosphine) nickel dichloride, 0.65 g (4.4 mmol) of sodium iodide, 15.2 g (58.0 mmol) of triphenylphosphine and 22.75 g (348 mmol) of zinc were weighed into a 1 L three-necked flask equipped with a stirrer, a thermometer and a nitrogen inlet tube, and then the mixture was purged with a dry nitrogen gas. Thereto was added 255 mL of N,N-dimethylacetamide (DMAc), and the reaction mixture was kept stirring while maintaining the reaction temperature at 80° C. for 3 hours. Then the reaction mixture was diluted with 480 mL of DMAc, and insoluble matter was filtered off.

The resulting solution was charged into a 2 L three-necked flask equipped with a stirrer, a thermometer and a nitrogen inlet tube. The solution was stirred while heating at 115° C., and 37.5 g (432 mmol) of lithium bromide was added thereto. After stirring for 7 hours, the reaction mixture was poured into 7 L of deionized water to precipitate the product. The precipitate was washed with acetone, 1 N HCl and pure water in this order, and then dried to obtain the intended polymer of 70 g. The mass average molecular weight (Mw) of the resulting polymer was 335,000. Therefore, the resulting polymer was presumed to be the sulfonated polyarylene expressed by the formula (XIII). The ion-exchange capacity of the polymer was 2.3 meq/g.

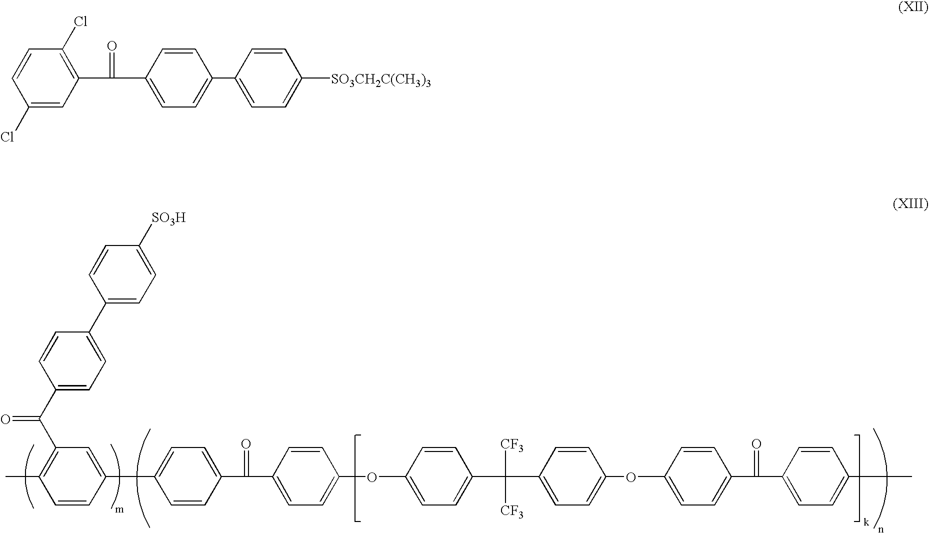

### Comparative Example 2

54.5 g (86.8 mmol) of 4′-(2,5-dichlorobenzoyl)-biphenyl-2′,4-disulfonic acid neopentyl expressed by the following structural formula (XIV), 34.3 g (3.2 mmol) of a hydrophobic unit (Mn=11,200) expressed by the above structural formula (II), 1.77 g (3.0 mmol) of bis(triphenylphosphine) nickel dichloride, 0.41 g (2.7 mmol) of sodium iodide, 9.44 g (36.0 mmol) of triphenylphosphine and 14.1 g (216 mmol) of zinc were weighed into a 1 L three-necked flask equipped with a stirrer, a thermometer and a nitrogen inlet tube, and then the mixture was purged with a dry nitrogen gas. Thereto was added 270 mL of N,N-dimethylacetamide (DMAc), and the reaction mixture was kept stirring while maintaining the reaction temperature at 80° C. for 3 hours. Then the reaction mixture was diluted with 480 mL of DMAc, and insoluble matter was filtered off.

The resulting solution was charged into a 2 L three-necked flask equipped with a stirrer, a thermometer and a nitrogen inlet tube. The solution was stirred while heating at 115° C., and 23 g (260 mmol) of lithium bromide was added. After stirring for 7 hours, the reaction mixture was poured into 7 L of deionized water to precipitate the product. The precipitate was washed with acetone, 1 N HCl and pure water in this order, and then dried to obtain the intended polymer of 70 g. The mass average molecular weight (Mw) of the resulting polymer was 240,000. Therefore, the resulting polymer was presumed to be the sulfonated polyarylene expressed by the formula (XV). The ion-exchange capacity of the polymer was 2.3 meq/g.

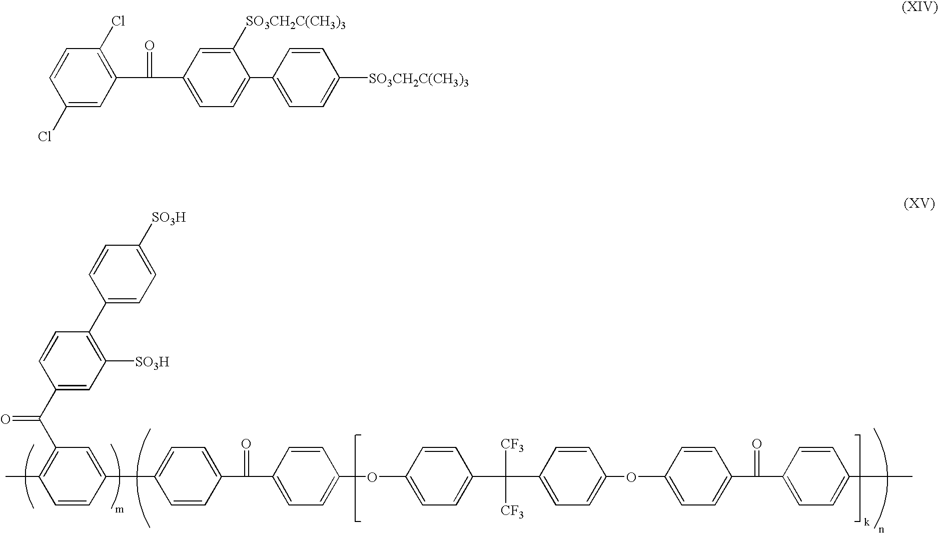

### Preparation of Film for Evaluation

Polymers provided in Examples 1-5 and Comparative Examples 1 and 2 were dissolved, respectively, in N-methyl-2-pyrolidone at a concentration of 14-16%. After casting on a glass plate, the polymer was dried to obtain a film having a film thickness 40 μm.

### Preparation of Membrane-Electrode Assembly

Platinum particles were supported in a carbon black (furnace black) having an average particle size of 50 nm in a mass ratio 1:1 of carbon black: platinum to thereby prepare catalyst particles. The catalyst particles were dispersed uniformly into a perfluoroalkylene sulfonic acid polymer compound (Nafion (product name), by DuPont) solution as an ion conductive binder in a mass ratio 8:5 of ion conductive binder: catalyst particles, thereby preparing a catalyst paste.

The catalyst paste was coated on both sides of the proton conductive membrane including sulfonated polyarylene prepared in Examples 1 to 5 and Comparative Examples 1 and 2 by use of a bar coater to give the platinum content of 0.5 mg/cm², and was dried to prepare an electrode coated membrane (CCM: Catalyst Coated Membrane). The drying included a first drying step conducted at 100° C. for 15 minutes, followed by a second drying step conducted at 140° C. for 10 minutes.

The carbon black and polytetrafluoroethylene (PTFE) particles were mixed in a mass ratio of 4:6 of carbon black: PTFE particles, and the resulting mixture was dispersed uniformly in ethylene glycol to prepare a slurry. Then, the slurry was coated, and dried on one side of the carbon paper to form a foundation layer. Two gas diffusion layers, which were formed of the foundation layer and the carbon paper, were prepared.

The CCM intervened at the side of the foundation layer of the gas diffusion layer, and then was subjected to hot pressing to obtain a membrane-electrode assembly. The hot pressing was conducted at 160° C. and 3 MPa for 5 minutes. In addition, the solid polymer electrolyte fuel cell may be constructed from the membrane-electrode assembly obtained according to the present Examples in such a way that a separator, being capable of serving also as a gas passage, is laminated on the gas diffusion layer.

### Evaluation

Using the obtained film, a water-resistance test and a proton conductivity measurement were performed. Also, a membrane-electrode assembly was made by using the obtained film, and the power generation property was evaluated. The results are summarized in Table 1.

TABLE 1

| | | | EXAM- | EXAM- | EXAM- | EXAM- | EXAM- | COMPARATIVE | COMPARATIVE |
|---|---|---|---|---|---|---|---|---|---|
| | | | PLE 1 | PLE 2 | PLE 3 | PLE 4 | PLE 5 | EXAMPLE 1 | EXAMPLE 2 |
| ION-EXCHANGE CAPACITY | | meq/g | 2.3 | 2.3 | 2.3 | 2.3 | 2.3 | 2.3 | 2.3 |
| WATER | 95° C. × 24 | % | 103 | 102 | 103 | 102 | 101 | 128 | 118 |
| RESISTANCE | HOURS | | | | | | | | |
| TEST | 120° C. × 24 | | 118 | 112 | 115 | 115 | 118 | 154 | 136 |
| | HOURS | | | | | | | | |
| PROTON | 50% RH | S/cm | 0.055 | 0.058 | 0.052 | 0.050 | 0.050 | 0.028 | 0.024 |
| CONDUCTIVITY | 70% RH | | 0.156 | 0.158 | 0.152 | 0.145 | 0.150 | 0.128 | 0.125 |
| (85° C.) | 90% RH | | 0.338 | 0.341 | 0.335 | 0.330 | 0.332 | 0.333 | 0.335 |
| POWER | 50/50% | V | 0.601 | 0.603 | 0.595 | 0.591 | 0.593 | 0.530 | 0.527 |
| GENERATION | RH | | | | | | | | |
| PERFORMANCE | 100/100% | | 0.667 | 0.668 | 0.666 | 0.660 | 0.665 | 0.661 | 0.663 |
| | RH | | | | | | | | |

| | | | | | | | |
|---|---|---|---|---|---|---|---|
| DURABILITY IN POWER GENERATION | ∘ | ∘ | ∘ | ∘ | ∘ | x | x |

According to the Examples, by using the sulfonated polyarylene having a specific constitutional unit, the proton conductivity is improved particularly in a low-humidity environment, so that a membrane-electrolyte assembly is produced exhibiting superior power generation performance under a wide range of humidified conditions. Moreover, the improvement of swelling property suppresses the dimensional change under a humidified environment, whereby a membrane-electrode assembly having superior resistance against fatigue breakdown due to repetition of swelling and drying can be obtained.

What is claimed is:

1. A membrane-electrode assembly for solid polymer electrolyte fuel cells,
wherein: an anode electrode is provided to one surface of a proton conductive membrane; and a cathode electrode is provided to another surface of the proton conductive membrane, the proton conductive membrane comprising a constitutional unit expressed by the following general formula (1′): 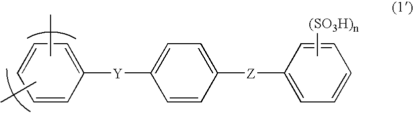
wherein, Y represents —CO— or —SO₂—; Z represents a direct bond, —CO—, —SO₂— or —SO—; and n represents an integer of 2 to 5.

2. A membrane-electrode assembly for solid polymer electrolyte fuel cells according to claim 1, wherein the proton conductive membrane further comprises a constitutional unit expressed by the following general formula (2): 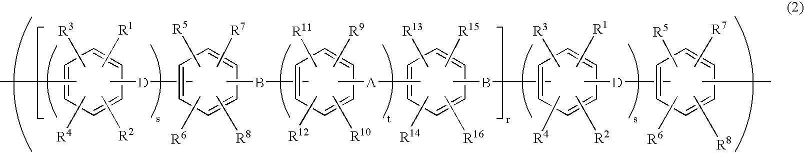
wherein, A and D each independently represent at least one structure selected from the group consisting of a direct bond, —O—, —S—, —CO—, —SO₂—, —SO—, —CONH—, —COO—, —(CF₂)ᵢ— (i is an integer of 1 to 10), —(CH₂)ⱼ— (j is an integer of 1 to 10), —CR′₂—(R′ represents an aliphatic hydrocarbon group, aromatic hydrocarbon group, or halogenated hydrocarbon group), a cyclohexylidene group, and fluorenylidene group; B independently represents an oxygen atom or a sulfur atom; R¹ to R¹⁶ may be identical or different from each other, and represent at least an atom or a group selected from the group consisting of a hydrogen atom, fluorine atom, alkyl group, partially or fully halogenated alkyl group, allyl group, aryl group, nitro group and nitrile group; s and t are each independently an integer of 0 to 4; and r is an integer of 0 or not less than 1.

3. A membrane-electrode assembly for solid polymer electrolyte fuel cells according to claim 1 or 2, wherein the constitutional unit expressed by the above general formula (1′) is a constitutional unit expressed by the following general formula (1′a): 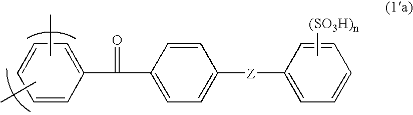
wherein, Z represents a direct bond, —CO—, —SO₂— or —SO—;
and n represents an integer of 2 to 5.
